(19) United States
(12) Patent Application Publication
(10) Pub. No.: US 2013/0017042 A1
(43) Pub. Date: Jan. 17, 2013

(54) MANIPULATOR, MANUFACTURING MACHINE AND PRODUCTION LINE USING THE SAME

(71) Applicant: PEI-CHONG TANG, Tu-Cheng (TW)

(72) Inventor: PEI-CHONG TANG, Tu-Cheng (TW)

(73) Assignee: HON HAI PRECISION INDUSTRY CO., LTD., Tu-Cheng (TW)

(21) Appl. No.: 13/450,721

(22) Filed: Apr. 19, 2012

(30) Foreign Application Priority Data
Jul. 15, 2011 (CN) 201110198779.9

(51) Int. Cl. B25J 11/00; B25J 18/00

(52) U.S. Cl. 414/225.01; 414/590

(57) ABSTRACT

A manipulator includes a first base, a second base, a rotating shaft, a swing arm, and a grasping member. The second base is mounted to the first base, and capable of moving along an X-axis with respect to the first base. The rotating shaft is mounted to the second base, and capable of rotating around a Z-axis perpendicular to the X-axis. The swing arm is mounted to the rotating shaft, and capable of moving along the Z-axis. The grasping member is mounted to a swinging arm wherein the grasping member is taken by the swing arm to rotate on a plane perpendicular to the Z-axis.

### BACKGROUND

1. Technical Field

The present disclosure relates to automatic production lines, and more particularly to a workpiece manipulator, a manufacturing machine and an automatic production line using the manipulator.

2. Description of Related Art

Workpiece manipulators are used in automatic production systems. However, such workpiece manipulators are relatively large and complex structure, so such manipulators are not suitable for small and compact production lines.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a manipulator.

FIG. 2 is a first exploded view of the manipulator in FIG. 1.

FIG. 3 is similar to FIG. 2, but viewed from another angle.

FIG. 4 is a second exploded view of the manipulator in FIG. 1.

FIG. 5 is similar to FIG. 4, but viewed from another angle.

FIGS. 6-8 show the manipulator in FIG. 1 in different states of working.

FIG. 9 is an isometric view of a machine for manufacturing using the manipulator in FIG. 1.

FIG. 10 is an isometric view of a production line using the manipulator in FIG. 1.

### DETAILED DESCRIPTION

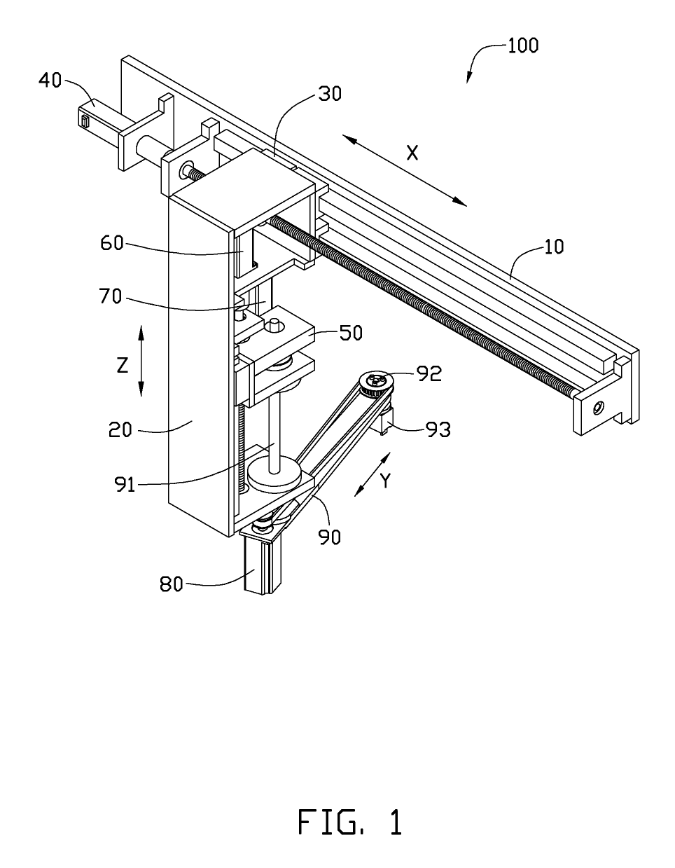

FIG. 1 shows an embodiment of the manipulator 100 applied to a production line to fetch, load, and unload workpieces and materials. The manipulator 100 is capable of moving in a three dimension space, along the X-axis, the Y-axis, and the Z-axis. The three axes X, Y, and Z are perpendicular to each other.

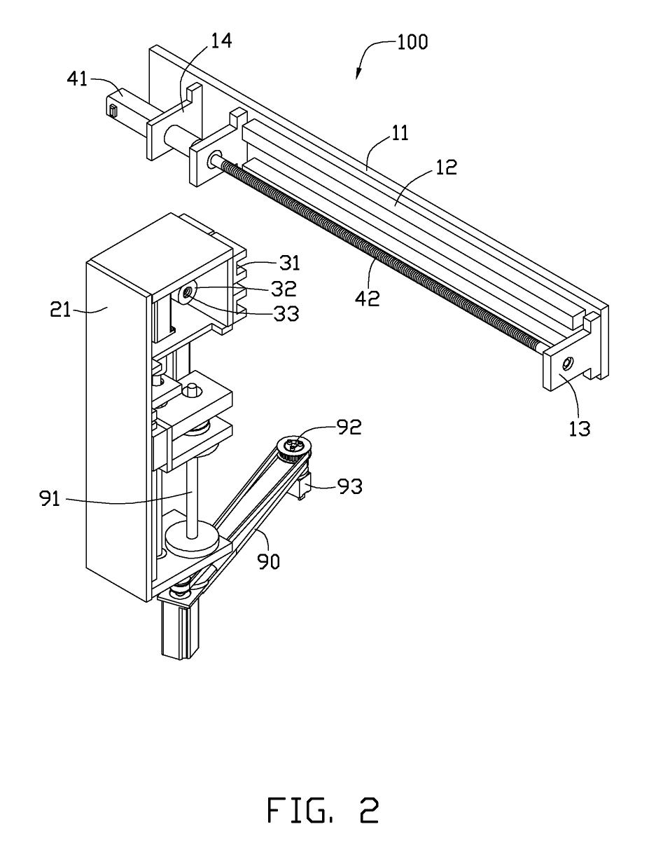

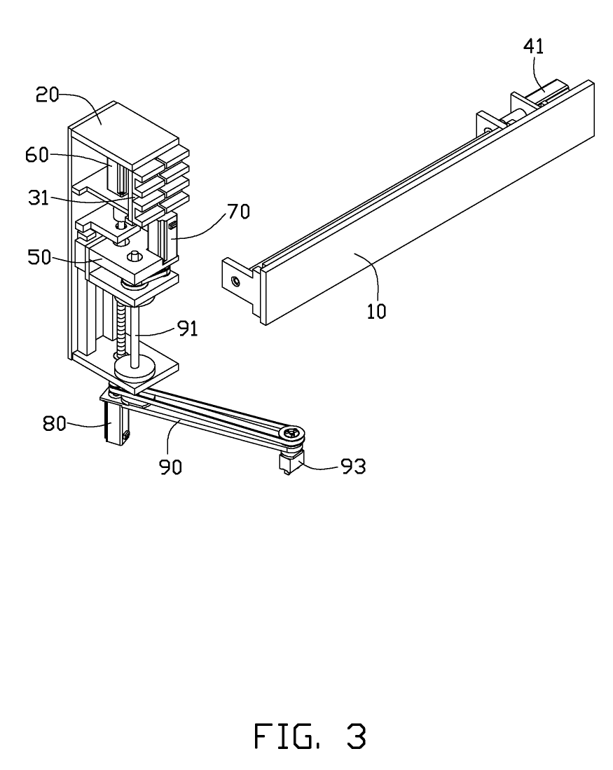

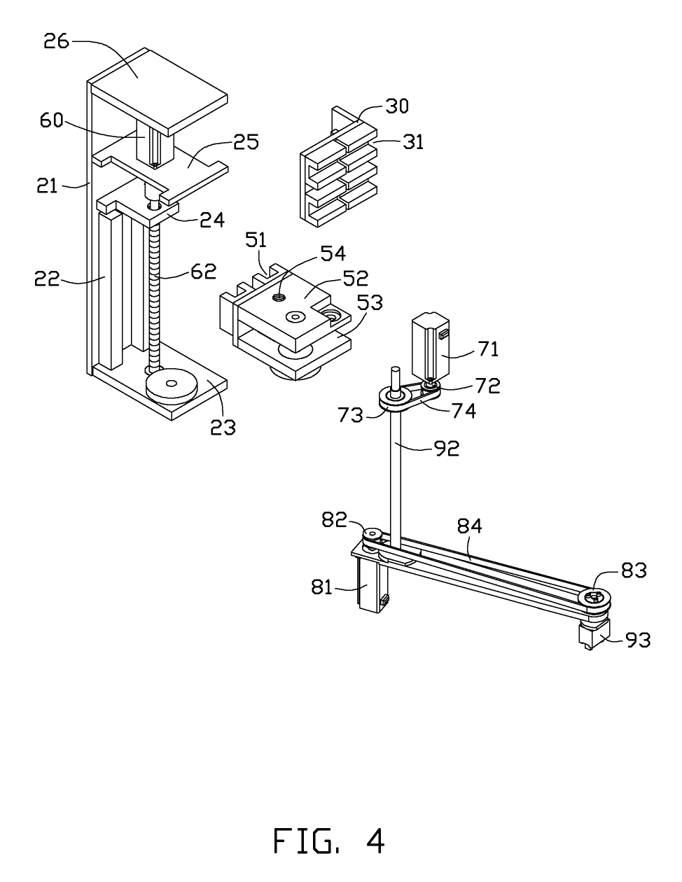

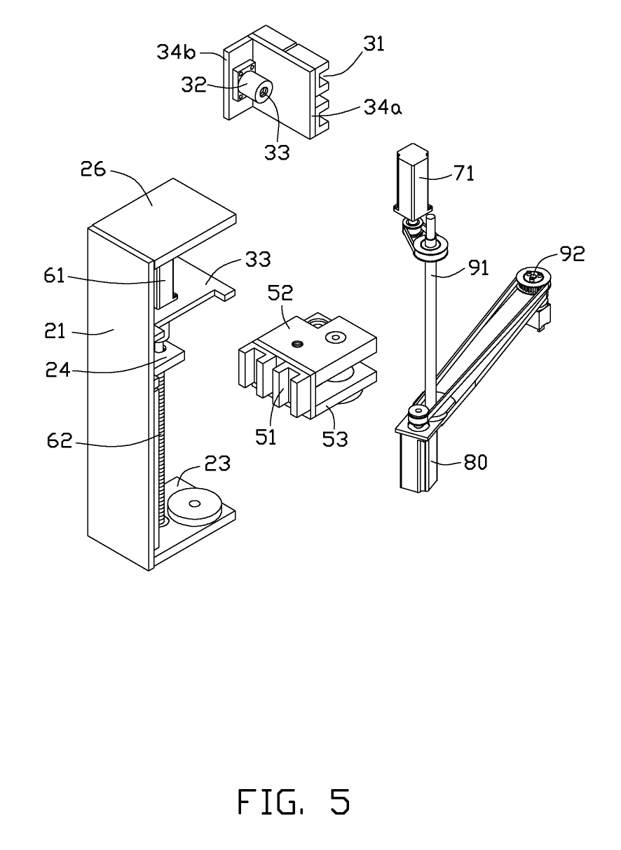

Referring to FIGS. 2-5, the manipulator 100 includes a first base 10, a second base 20, a first linkage member 30, a first driving member 40, a second linkage member 50, a second driving member 60, a third driving member 70, a fourth driving member 80, a swing arm 90, a first rotating shaft 91, a second rotating shaft 92, and a grasping member 93.

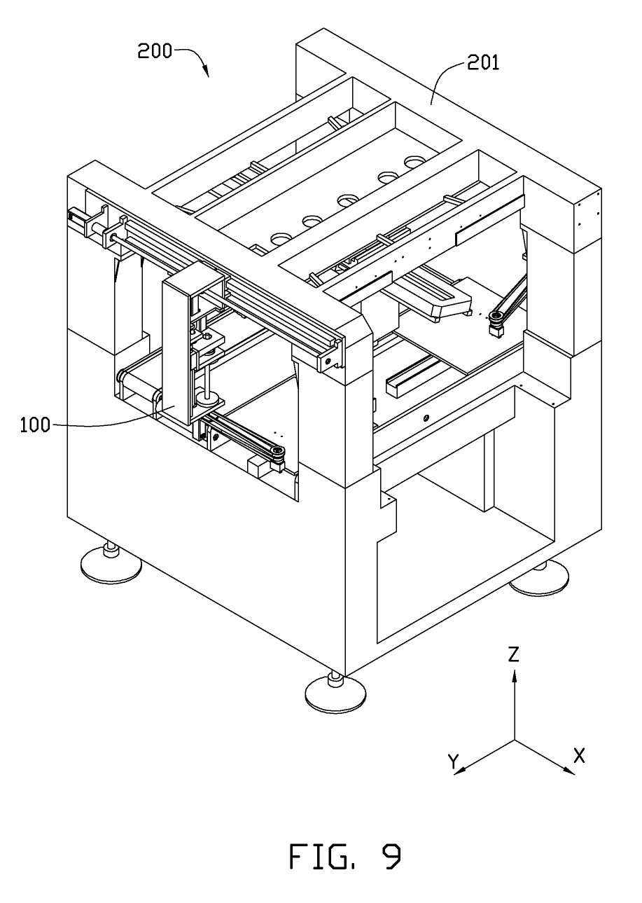

The first base 10 is secured on a manufacturing machines 200 (see FIG. 9). The first linkage member 30 is secured to the second base 20 and movably connected to the first base 10. The first driving member 40 is secured on the first base 10 and the first linkage member 30. The first driving member 40 drives the first linkage member 30 to move along the first base 10, and the second base 20 is caused to move with the first linkage member 30. The second linkage member 50 is movably connected to the second base 20. The second driving member 60 is secured on the second base 20 and the second linkage member 50, and drives the second linkage member 50 to move along the second base 20. The swing arm 90 is rotatably connected to the second linkage member 50 and the second base 20 by the first rotating shaft 91. The second driving member 70 is secured on the second linkage member 50, and drives the first rotating shaft 91 to rotate. The grasping member 93 is rotatably connected to the swing arm 90 by the second rotating shaft 92 to grasp the material. The fourth driving member 80 is secured on the swing arm 90 to drive the grasping member 93 to rotate. In this embodiment, the first base 10 is placed along the X-axis, such that the first linkage member 30 is caused to move along the X-axis. The second base 20 is placed along the Z-axis, such that the second linkage member 50 is caused to move along the Z-axis.

The first base 10 includes a first body 11, two first guiding rails 12 protruding from the first body 11 in parallel with each other, two first fixing member 13 positioned on two opposite ends of the first guiding rails 12, and a second fixing member 14 positioned on one side of the first fixing member 13 and away from the first guiding rail 12. The two first guiding rails 12 are linear rails, placed along the X-axis on the first body 11.

The first driving member 40 includes a first motor 41 and a first screw shaft 42. The first motor 41 is fixed on the second fixing member 14. One end of the first screw shaft 42 is connected to the first motor 41, the other end of the first screw shaft 42 passes through one first fixing member 13, the first linkage member 30, and the other first fixing member 13 in that order. The first screw shaft 42 is placed along the X-axis on the first base 10, such that the first screw shaft 42 is parallel to the two first guiding rails 12. The first screw shaft 42 is driven to rotate by the first motor 41.

The first linkage member 30 includes two side walls 34a and 34b perpendicular with each other. Two first sliding grooves 31 are defined on the side wall 34a, and a third fixing member 32 is set on the side wall 34b. The fixing member 32 defines a first screw hole 33. The first linkage member 30 is mounted to the first base 10 by enabling the first screw shaft 42 to pass thought the third fixing member 32 via the first screw hole 33, and enabling the two first guiding grooves 31 to receive the two first guiding rails 12. If the first screw shaft 42 is driven by the first motor 41 to rotate, the first screw shaft 42 and the first screw hole 33 enable the first linkage member 30 to move along the X-axis, such that the second base 20 secured to the first linkage member 30 is also moving along the X-axis.

The second base 20 includes second body 21, two second guiding rails 22 protruding from the second body 21 in parallel with each other, and a fourth fixing member 23, a fifth fixing member 24, a sixth fixing member 25, and a seventh fixing member 26 being placed in order along the Z-axis at intervals. The two second guiding rails 22 have their longitudinal axis parallel to the Z-axis, and the fourth fixing member 23 and the fifth fixing member 24 are positioned at two opposite ends of the two second guiding rails 22. The first linkage member 30 is received between the sixth fixing member 25 and the seventh fixing member 26.

The second driving device 60 includes a second motor 61 and a second screw shaft 62. The second motor 61 is fixed on the sixth fixing member 25, and positioned between the first linkage member 30 and the second body 21. One end of the second screw shaft 62 is secured on the second motor 61, the other end of the second screw shaft 62 passes through the fifth fixing member 24, the second linkage member 50, and the fourth fixing member 23 in that order. The second screw shaft 62 is driven to rotate by the second motor 61.

Two parallel second sliding grooves 51 are defined on one side of the second linkage member 50. An eighth fixing member 52 and a ninth fixing member 53 protrude from opposite sides of the second linkage member 50. The eighth fixing member 52 and the ninth fixing member 53 are parallel to each other, and each defines a coaxial through hole (second screw holes 54). The second linkage member 50 is mounted to the second base 20 by enabling the second screw shaft 62 to pass through the eighth fixing member 52 and the ninth fixing member 53 via the second screw holes 54, and enables the two second guiding grooves 51 to receive the two second guiding rails 22. When the second screw shaft 62 is driven by the second motor 61 to rotate, the second screw shaft 62 and the second screw holes 54 to enable the second linkage member 50 to move along the Z-axis, such that the first rotating shaft 91 secured to the second linkage member 50 is also moving along the Z-axis.

The third driving member 70 includes a third motor 71, a first conveyor wheel 72, a second conveyor wheel 73, and a first conveyor belt 74. The third motor 71 is secured on the eighth fixing member 52. The first and the second conveyor wheel 72 and 73 are positioned on the ninth fixing member 53. A part of the motor 73 passes through the eighth fixing member 52 to connect to the first conveyor wheel 72. The second conveyor wheel 73 is sleeved on the first rotating shaft 91. The diameter of the first conveyor wheel 72 is smaller than that of the second conveyor wheel 73. The first conveyor belt 74 is sleeved on the first and the second conveyor wheels 72 and 73. The first and the second conveyor wheels 72 and 73 are driven to rotate in an X-axis/Y-axis horizontal plane. The first rotating shaft 91 is moved, taking the swing arm 90 with it, when the second conveyor wheel 73 is rotated.

The swing arm 90 is a long and narrow board. The first rotating shaft 91 and the second rotating shaft 92 extend from the swing arm 90 along the Z-axis. The first rotating shaft 91 perpendicularly protrudes from one end of the swing arm 90, and passes through the fourth fixing member 23, the fifth fixing member 24, the second conveyor wheel 73, the ninth fixing member 53, and the eighth fixing member 52 in that order. The first rotating shaft 91 is located at one side of the second screw shaft 62 away from the second base 21. The first rotating shaft 91 is capable of rotating with respect to the fourth fixing member 23, the fifth fixing member 24, the ninth fixing member 53, and the eighth fixing member 52, and is fixed on the second conveyor wheel 73. The first rotating shaft 91 connects the swing arm 90 to the second linkage member 50 and the swing arm 90 is positioned under the second base 20. Further, the swing arm 90 is perpendicular to the Z-axis, such that the swing arm 90 can be rotated in the X-axis/Y-axis plane.

The second rotating shaft 92 passes through the swing arm 90 with two opposite ends located at opposite sides of the swing arm 90. The second rotating shaft 92 is capable of rotating with respect to the swing arm 90. The grasping member 93 is fixed to one end of the second rotating shaft 92 under the swing arm 90.

The fourth driving member 80 includes a fourth motor 81, a third conveyor wheel 82, a fourth conveyor wheel 83, and a second conveyor belt 84. The fourth motor 81 is fixed to the underside of the swing arm 90. The third conveyor wheel 82 and the fourth conveyor wheel 83 are positioned on a side of the swing arm 90 away from the grasping member 93. The third conveyor wheel 82 and the fourth conveyor wheel 83 are positioned on opposite ends of the swing arm 90. The fourth motor 81 passes through the swing arm 90 to be fixed to the third conveyor wheel 82. The fourth conveyor wheel 83 is sleeved on the second rotating shaft 92. The diameter of the third conveyor wheel 82 is smaller than that of the fourth conveyor wheel 83. The second conveyor belt 84 is sleeved on the third and fourth conveyor wheels 82 and 83. The second conveyor belt 84 can enable the rotation of the fourth conveyor wheel 83 by the third conveyor wheel 82 when the fourth motor 81 drives the third conveyor wheel 82 to rotate. The second rotating shaft 92 is being moved, taking the grasping member 93 with it, when the fourth conveyor wheel 83 is being rotated. In this embodiment, the grasping member 93 can be a standard element or a non-standard element for grasping material.

As described above, the swing arm 90 can move with the first and the second linkage members 30, 50 along the X-axis, and along the Z-axis, and the swing arm 90 can further rotate in the X-axis/Y-axis plane, so the swing arm 90 can also change its position with respect to the Y-axis. Essentially, the minpulater 100 can be located in any desired positon by changing the position of the swing arm 90 with respect to the X-axis, the Y-axis, and the Z-axis. The capabilities of the manipulator 100 can be best described as below.

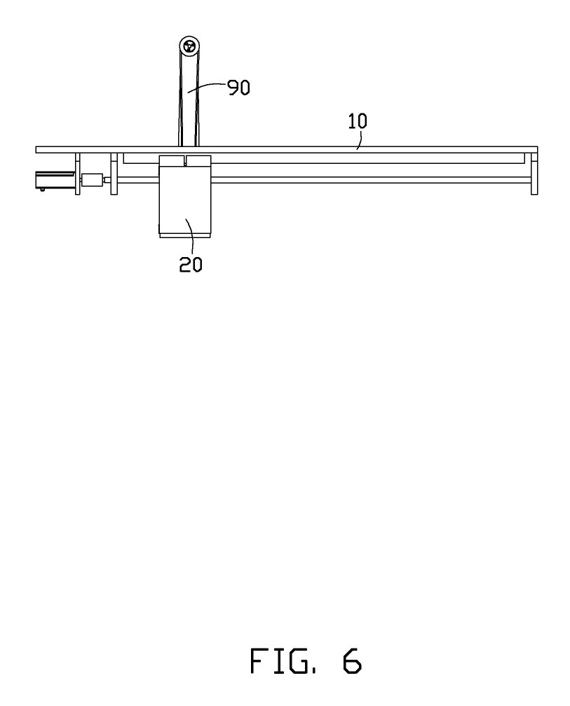

In analyzing the capabilities of the manipulator 100, variables X, Y, Z, T, x, z, t, and d are involved. The variables X, Y and Z indicate the positions of the grasping member 93 with respect to the X-axis, the Y-axis, and Z-axis. T indicates an angle of the grasping member 93 with respect to the Z-axis. The variables x, y and z applying to the manipulator 100 indicate a variable of the first linkage member 30 and the second linkage member 50 moving certain distances with respect to the X-axis, and Z-axis. The variable t indicates an angle the grasping member 93 rotating with respect to the Z-axis. The variable d indicates a distance between the axis of the first rotating shaft 91 and the axis of the second rotating shaft 92. In this embodiment, the grasping member 93 is placed along the Y-axis and away from the second base 20, FIG. 6 shows the grasping member 93 located at its original position.

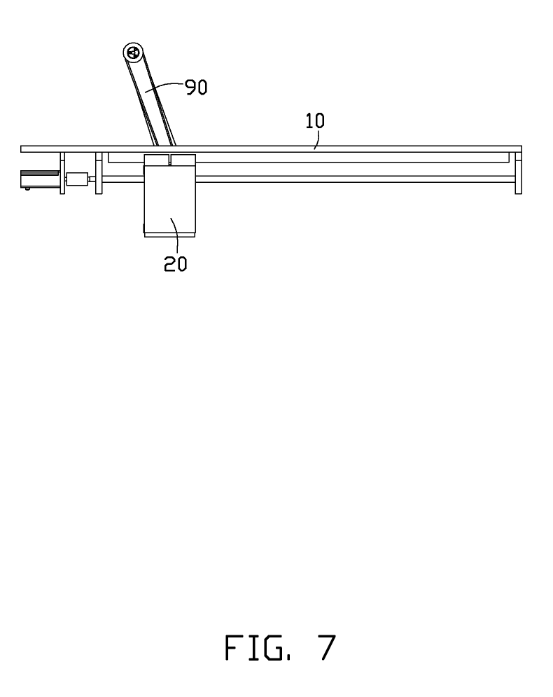

Referring to FIG. 7, after the swing arm 90 is clockwise rotated through an angle K, the variables can be indicated as:

X=x+(sin|k|)*d;

Y=(cos|k|)*d;

Z=z;

T=t−|k|.

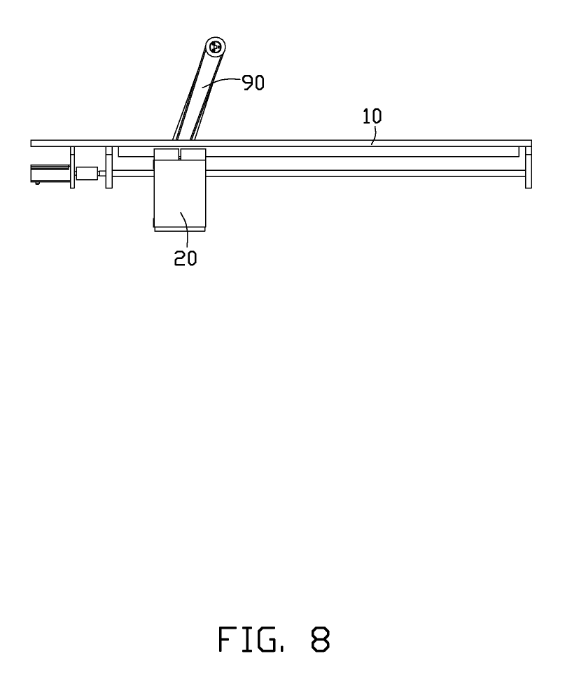

Referring to FIG. 8, after the swing arm 90 is anticlockwise rotated through an angle K, the variables can be indicated as:

X=x−(sin|k|)*d;

Y=(cos|k|)*d;

Z=z;

T=t+|k|.

FIG. 9 shows an embodiment of a manufacturing machine 200. The manufacturing machines 200 includes a frame 201 and a manipulator 100. The manipulator 100 is mounted to one side of the frame 201, the manipulator 100 can be moved from the exterior of the frame 201 to the interior and back again. In another embodiment, a single manufacturing machine 200 can be configured with two or more than two manipulators 100 depending on an amount of work-stations of the manufacturing machine 200.

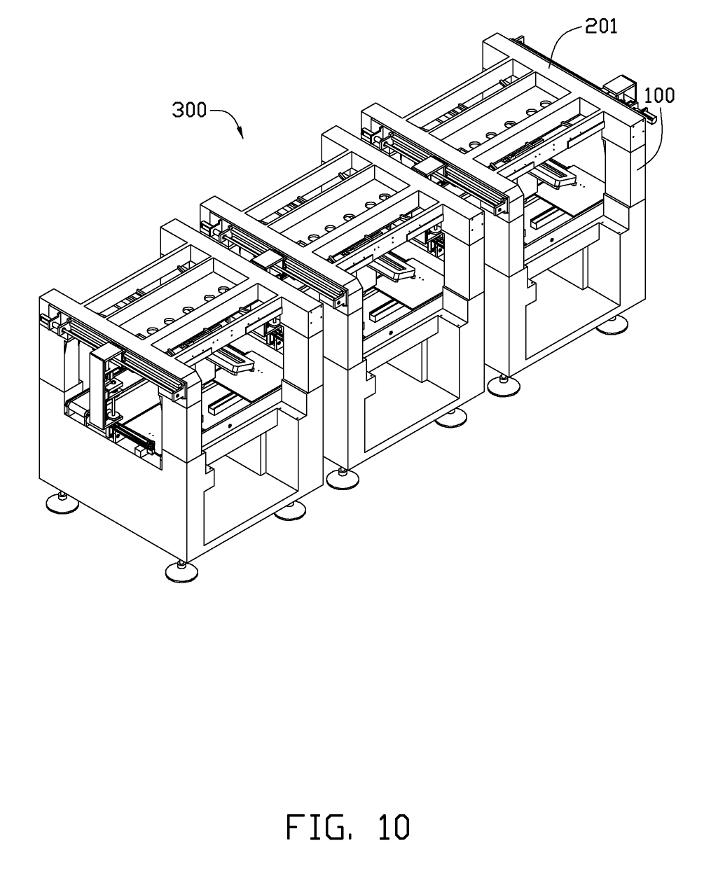

FIG. 10 shows an embodiment of a production line 300 using the manufacturing machines 200. The production line 300 is composed of a plurality of manufacturing machines 200. For example, the production line 300 can be obtained by placing the plurality of manufacturing machines 200 in sequence.

Although relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A manipulator comprising:
a first base;
a second base mounted to the first base, and capable of moving along an X-axis with respect to the first base;
a rotating shaft rotatably mounted to the second base, and capable of rotating around a Z-axis perpendicular to the X-axis;
a swing arm mounted to the rotating shaft, and capable of moving along the Z-axis; and
a grasping member mounted to the swing arm, wherein the grasping member is taken by the swing arm to rotate on a plane perpendicular to the Z-axis.

2. The manipulator of claim 1, wherein the swing arm extends from the rotating shaft along a Y-axis, which is perpendicular to the X-axis and the Z-axis.

3. The manipulator of claim 1, wherein the grasping member is mounted to one end of the swing arm and away from the rotating shaft.

4. The manipulator of claim 1, wherein the grasping member is capable of rotating around the Z-axis.

5. The manipulator of claim 1, wherein the manipulator further comprises a first driving member and a first linkage member, the first linkage member is movably mounted to the first base, and the second base is attached to the first linkage member, the first driving member drives the first linkage member to move, and as a result the second base moves with the first linkage member.

6. The manipulator of claim 1, wherein the manipulator further comprises a second driving member and a second linkage member, the second linkage member is movably mounted to the second base, the rotating shaft is secured to the linkage member, the second driving member drives the second linkage member to move, and as a result the rotating shaft moves with the second linkage member.

7. The manipulator of claim 1, wherein the manipulator further comprises another rotating shaft, and a fourth driving member, the another rotating shaft is rotatably mounted to the swing arm, the grasping member is secured on the another rotating member, the fourth driving member drives the another rotating shaft to rotate and as a result the grasping member rotates with the another rotating shaft.

8. A manufacturing machine comprising at least one manipulator, the manipulator comprising:
a frame;
a swing arm with one end secured to the frame, and capable of moving along an X-axis and a Z-axis, the X-axis and the Z-axis being perpendicular with each other, the swing arm further capable of rotating around the Z-axis; and
a grasping member is mounted to the opposite end of the swing arm, and capable of rotating with the swing arm on a plane which is perpendicular with the Z-axis.

9. The manufacturing machine of claim 8, wherein the manipulator further comprises a first base and a second base, the first base is placed along the X-axis, the second base is placed along a Y-axis which is perpendicular to the X-axis and Z-axis, the second base is movably mounted to the first base.

10. The manufacturing machine of claim 9, wherein the manipulator further comprises a first rotating shaft with an axes parallel to the Z-axis, one end of the first rotating shaft is rotatably mounted to the second base, the other end of the rotating shaft is mounted to the swing arm.

11. The manufacturing machine of claim 10, wherein the grasping member is mounted to one end of the swing arm and away from the rotating shaft.

12. The manufacturing machine of claim 10, wherein the manipulator further comprises a first driving member and a first linkage member, the first linkage member is movably mounted to the first base, and the second base is attached to the first linkage member, the first driving member drives the first linkage member to move, and as a result the second base moves with the first linkage member.

13. The manufacturing machine of claim 10, wherein the manipulator further comprises a second driving member and a second linkage member, the second linkage member is movably mounted to the second base, the rotating shaft is secured to the linkage member, the second driving member drives the second linkage member to move, and as a result the rotating shaft moves with the second linkage member.

14. The manufacturing machine of claim 8, wherein the grasping member is capable of rotating around the Z-axis.

15. The manufacturing machine of claim 14, wherein the manipulator further comprises another rotating shaft, and a fourth driving member, the another rotating shaft is rotatably mounted to the swing arm, the grasping member is secured on the another rotating shaft, the fourth driving member drives the another rotating shaft to rotate and as a result the grasping member rotates with the another rotating shaft.

16. A production line comprising a plurality of manufacturing machines, each of the plurality of the manufacturing machines comprising at least one manipulator, the manipulator comprising:
a frame;
a first base mounted to the frame;
a second base mounted to the first base, and capable of moving along an X-axis with respect to the first base;
a rotating shaft rotatably mounted to the second base, and capable of rotating around a Z-axis perpendicular to the X-axis;
a swing arm mounted to the rotating shaft, and capable of moving along the Z-axis; and
a grasping member mounted to the swing arm, wherein the grasping member is taken by the swing arm to rotate in a plane perpendicular to the Z-axis.

17. The production line of claim 16, wherein the swing arm is placed along a Y-axis, which is perpendicular to the X-axis and the Z-axis.

18. The production line of claim 16, wherein the grasping member is capable of rotating around the Z-axis.

19. The production line of claim 16, wherein the manipulator further comprises a first driving member and a first linkage member, the first linkage member is movably mounted to the first base, and the second base is attached to the first linkage member, the driving member drives the first linkage member to move, and as a result the second base moves with the first linkage member.

20. The production line of claim 16, wherein the manipulator further comprises a second driving member and a second linkage member, the second linkage member is movably mounted to the second base, the rotating shaft is secured to the linkage member, the second driving member drives the second linkage member to move, as a result the rotating shaft moves with the second linkage member.
